(19) United States
(12) Patent Application Publication
(10) Pub. No.: US 2010/0028518 A1
(43) Pub. Date: Feb. 4, 2010

(54) Oxidation Stability Using Natural Antioxidants

(76) Inventors: Leslie George West, Winnetka, IL (US); Robert Charles Dinwoodie, Glenview, IL (US); Ida Chang Tsui, Libertyville, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 12/509,787

(22) Filed: Jul. 27, 2009

Related U.S. Application Data
(60) Provisional application No. 61/084,792, filed on Jul. 30, 2008.

(51) Int. Cl. C11B 5/00; A23L 2/44; A23L 1/24

(52) U.S. Cl. 426/544

(57) ABSTRACT

Comestibles including nicotianamine as a natural replacer for EDTA and methods of use thereof are provided.

### CROSS-REFERENCE To RELATED APPLICATION

This application claims benefit of U.S. Provisional Application No. 61/084,792, filed Jul. 30, 2008, which is hereby incorporated herein by reference in its entirety.

### FIELD

The field relates to natural antioxidants, and in particular natural antioxidants in comestibles.

### BACKGROUND

Oxidation is a process that occurs in food products, causing foods to spoil and become unpleasing in taste and appearance. Oxidation reactions may occur when chemicals in food are exposed to oxygen in the air and free radicals are formed. It has been shown that free radicals may naturally occur, at least in part, due to the presence of iron- or copper-ion catalysts. Under normal conditions, animal and plant tissues naturally contain antioxidants which prevent oxidative damage. However, in foods many of these naturally occurring antioxidants break down and no longer impart their protective properties to the food. Oxidation of fat and oil in food can lead to rancidity and, in fruit, can cause discoloration. This oxidation ultimately leads to spoilage of the food and a corresponding loss of nutritional value and favorable organoleptic properties. As a result, removing free metal ions, such as iron and copper ions, present in food products can result in oxidative stability to foods that are more resistant to spoilage and have preserved flavor quality and improved color retention.

Traditionally, ethylenediaminetetraacetic acid or EDTA has been used in food and beverage products to prevent oxidation and spoilage due to its capacity to chelate metals. This material generally enjoys widespread use in industry, medicine, and laboratory science due to its relatively high capability to chelate metal ions. In the food and beverage industry, EDTA is often used to protect products from oxidation and spoilage and to improve flavor quality and color retention. EDTA, however, is a synthetic or artificial ingredient.

Recently, there have been increased desires for the removal of artificial ingredients in food and beverage products and their replacement with natural alternatives. For example, artificial preservatives, colors and flavors have been successfully replaced, in some instances, with natural counterparts. Owing to its effectiveness, reasonable cost, and lack of viable alternatives, however, EDTA has so far been one of the more difficult artificial ingredients to replace. Attempts so far to replace or remove EDTA from foods and beverages have thus far yielded somewhat disappointing results. For example, naturally produced siderophores (from yeast and fungi) are effective metal chelators, but unacceptably add color to foods and beverages.

### SUMMARY

The present disclosure relates to an oxidatively stable comestible, such as a food or beverage product, comprising a comestible base and an effective amount of nicotianamine as a replacement for EDTA where the comestible also is substantially free of EDTA. In one aspect, the amount of nicotianamine should be effective to provide oxidative stability at least equivalent to the same comestible base containing an amount of EDTA. In one embodiment, the effective amount of nicotianamine is about 60 to about 400 ppm and in another embodiment about 60 to about 200 ppm of nicotianamine. In another embodiment, the effective amount of nicotianamine is effective to reduce formation of free radicals in the comestible to less than about 3, and more preferably less than about 2 microM Tempol equivalent after about 130 hours of incubation at about 37° C. In another aspect, the nicotianamine is effective to limit the amount of heptadienal generated from the comestible base to about 1500 ppb of less after about 7 weeks of storage. For example, the amount of nicotianamine is effective such that the headspace of the container holding the comestible has less than about 1500 ppb of heptadienal after about 7 weeks of storage at about 43° C. The comestible base may be a food, a beverage, a pharmaceutical, or other consumable item. Preferably, the comestible base is a salad dressing. More preferably, the salad dressing is mayonnaise.

The present disclosure is also directed to a method of preparing a nicotianamine containing product. The method involves providing a product, such as a food, a beverage, a pharmaceutical, or the like and combining an amount of nicotianamine effective to reduce oxidation of the product similar to the product having EDTA. The nicotianamine may be added to the product during the formulation of the product. Alternatively, the nicotianamine may be added to the product after its formulation. In one embodiment, the effective amount of nicotianamine is about 60 ppm to about 400 ppm. In another embodiment, the product is preferably a salad dressing and more preferably, the salad dressing is mayonnaise.

### BRIEF DESCRIPTION OF THE DRAWINGS

FIG. 1 is a graph demonstrating the efficacy of nicotianamine compared to EDTA; and

FIG. 2 is another graph demonstrating the efficacy of nicotianamine compared to EDTA.

### DETAILED DESCRIPTION

Foods and beverages including naturally occurring antioxidants are provided. In particular, food and beverages including effective amounts of nicotianamine (NA) to provide oxidative stability similar to EDTA are disclosed. By one approach, the NA is natural or is not synthetically or artificially formed. By another approach, the NA is obtained from a plant or other natural source. It has been discovered that nicotianamine may be able to provide the same preservative and protective effects provided by EDTA. This substitution of nicotianamine would allow the replacement of synthetic EDTA with the naturally occurring compound nicotianamine. In one aspect, about 60 to about 400 ppm, and in another aspect, about 60 to about 200 ppm NA is sufficient to impart oxidative stability similar to EDTA. In one particular example, about 60 to about 400 ppm NA is provided in salad dressings, such as mayonnaise, to form an oxidatively stable product that is also substantially free of EDTA. In one approach, the salad dressing includes lipids, water, emulsifiers such as eggs, edible acids and flavors in combination with effective amounts of NA.

For the purpose of this disclosure, food or beverage are generally intended to include any and all foods, food products, beverages, or beverage products that have previously had EDTA included as a preservative or antioxidant, and are intended for animal or human consumption. Additionally, food and beverage are generally intended to include any food, food products, beverage, or beverage products that desire preservation. Furthermore, it is intended that the terms food and beverage may also include other consumable products, including but not limited to, pharmaceuticals, health products, vitamins, and the like.

Further, for the purpose of his disclosure, the term “substantially free of EDTA” is intended to indicate a product having less than 1 weight % EDTA, preferably a product having less than 0.1 weight % EDTA, and more preferably a product containing no EDTA. In addition, the effective amounts of NA also do not impart any objectionable organoleptic changes to the foods, such as changes in color, taste, odor, or texture, such that the comestible with the NA has organoleptic properties similar to the comestible with EDTA.

Nicotianamine (NA) is a non-protein amino acid that is widely present in nature, especially in plants. NA generally refers to N-(N-(3-amino-3-carboxypropyl)-3-amino-3-carboxypropyl) azetidine-2-carboxylic acid and is generally found in plants such as tobacco, rice, Chinese matrimony vines, and beeches and can be obtained from the leaves of these plants. It is also known that nicotianamine can be found in kidney beans and soybeans and that an extract of the beans with water or hot water is treated with a synthetic resin to obtain purified nicotianamine.

The following provides examples of how nicotianamine may be extracted and obtained from various sources. It will be appreciated that other methods and sources of nicotianamine may also be used as needed. For example, nicotianamine has been isolated and purified by creating an aqueous extract of soybeans, subjecting the extract to ultrafiltration or size exclusion chromatography to obtain a fraction having a molecular weight of 1,000 or less, adding an organic solvent, and collecting the resulting precipitate. Additionally, the aqueous extract or fraction may be subjected to ion-exchange resin treatment and/or activated carbon filtration to further purify the nicotianamine containing product. In other examples, nicotianamine may also be obtained by genetically engineering yeast cells to overproduce the nicotianamine precursor S-adenosylmethionine (SAM). The SAM is then trimerized by nicotianamine synthase to create nicotianamine at significantly increased levels (See, e.g., W. Yasuaki, Metabolic engineering of Saccharomyces cervisiae producing nicotianamine: potential for industrial biosynthesis of a novel hypertensive substrate, Bioscience, biotechnology, and biochemistry (Japan), June 2006).

By one approach, the nicotianamine may be added to foods or beverages in a number of methods. For example, the nicotianamine may be added with other ingredients during the formation of the food or beverage or, by other approaches, may also be added after the final formation of the product. Specifically, nicotianamine should be added to the food or beverage in an amount effective to prevent levels of oxidation of the food or beverage similar to antioxidation effects obtained when EDTA was used instead. By one approach, about 60 to about 400 ppm nicotianamine is added to foods and beverages to achieve such similar anti-oxidative effects when the food or beverage is also substantially free of EDTA.

In one embodiment, nicotianamine is added to mayonnaise to prevent oxidation of the mayonnaise during storage. The nicotianamine may be added in place of EDTA or to supplement EDTA. In a preferred embodiment, the mayonnaise is substantially free of EDTA. In a preferred embodiment, the mayonnaise contains no EDTA. By another approach, the comestible, such as mayonnaise, preferably has a pH of between about 3.0 and about 5.0 and preferably has a titrateable acidity of between about 0.2 and about 0.5.

Advantages and embodiments of this invention are further illustrated by the following example, but the particular materials and amounts thereof recited in these examples, as well as other conditions and details, should not be construed to unduly limit the invention. All parts and percentages are by weight unless otherwise directed.

### EXAMPLES

### EXAMPLE 1

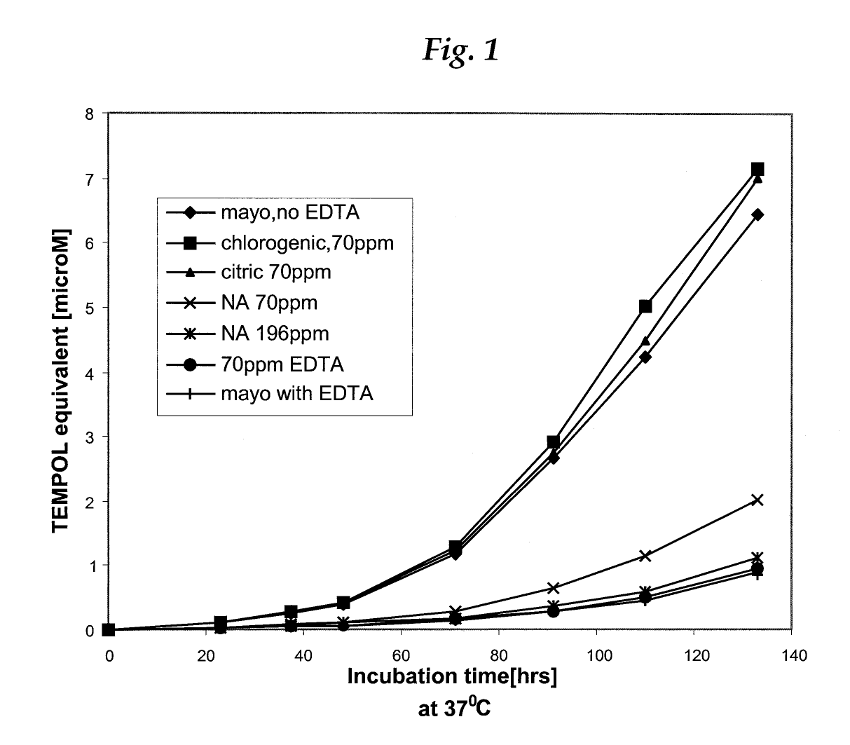

Samples to be tested were created by first forming a mayonnaise base, which contained no chelating agent. This mayonnaise base was used as a control and is labeled “Mayo, no EDTA” in FIG. 1, the mayonnaise base had a pH of about 3.7 and a titrateable acidity of about 0.31. Citric acid, chlorogenic acid, nicotianamine (NA), and EDTA were added to the mayonnaise base by stirring in the substances in the amounts indicated in FIG. 1. The sample labeled “mayo with EDTA” is a commercially available mayonnaise sample (Kraft REAL Mayonnaise, Kraft Foods, Northfield, Ill.) generally having about 70 ppm EDTA. The sample labeled “70 ppm EDTA” was a comparison sample prepared by blending 70 ppm of EDTA into the mayonnaise base similar to the other ingredients.

The samples were analyzed using quantitative electron paramagnetic resonance (EPR) to detect the formation of free radicals. The EPR techniques is an adaptation of Thomsen, “Quantification of Radical Formation in Oil-in-Water Food Emulsions by Electron Spin Resonance Spectroscopy” in Journal of Food Lipids, Volume 6, Issue 2, pages 149-158, June 1999, which is incorporated herein in its entirety. EPR is used to detect the presence of stable free radicals expressed as 4-hydroxy-2,2,6,6-tetramethylpiperidinyloxy (TEMPOL) equivalent measured at the micromolar (microM) level. Higher amounts of TEMPOL equivalent present in a sample indicates a lower ability to resist or prevent the formation of free radicals. Lower levels of TEMPOL equivalent indicate that the substance has a protective effect and aids in the prevention of the formation of free radicals. By preventing free radical formation and thereby lowering the amount of free radicals present in the product, oxidation of the product is avoided as well.

The resulting mayonnaise samples were incubated at about 37° C. and the presence of TEMPOL equivalent was measured at various time points. As shown in FIG. 1, while the samples containing no EDTA, 70 ppm chlorogenic acid, and 70 ppm citric acid displayed increased levels of free radical formation, the samples containing 70 ppm and 196 ppm of nicotianamine had levels of free radicals comparable to both mayonnaise samples containing EDTA. Therefore, the presence of nicotianamine imparted a protective effect on the mayonnaise sample equivalent to EDTA.

### EXAMPLE 2

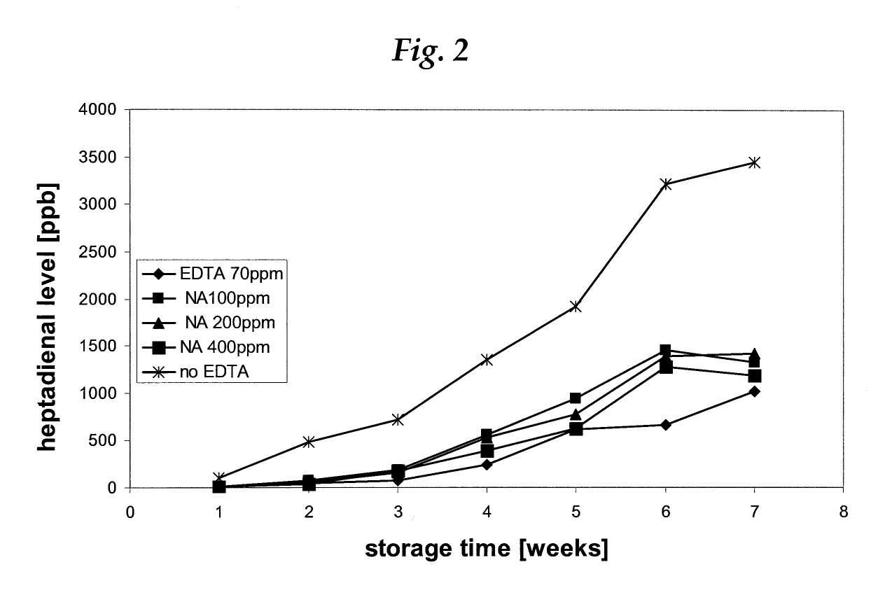

Similar to Example 1, samples to be tested were created by first forming a mayonnaise base. This mayonnaise base was used as a control and is labeled “no EDTA” in FIG. 2. About 100, 200, and 400 ppm of nicotianamine (NA) and about 70 ppm of EDTA were added to the mayonnaise base by stirring in the substances in the mayonnaise. The sample labeled “EDTA 70 ppm” was a comparison sample prepared by blending 70 ppm of EDTA into the mayonnaise base similar to the other chelating agents.

The various mayonnaise samples were subjected to an accelerated storage environment by incubating each of the samples for up to about 7 weeks at about 43° C. At weekly intervals, the headspace of the containers holding the samples was tested for the presence of heptadienal. Heptadienal is a compound that is generated from the oxidation of lipids and is used for this purpose to evaluate the rate and amount oxidation taking place during accelerated storage. Heptadienal levels were analyzed by first removing a gas sample from the headspace of each container. These gas samples were then subjected to gas chromatography to detect the presence and amount of heptadienal. Higher levels of heptadienal present indicate an elevated amount of oxidation, while lower levels of heptadienal present indicate a relatively lower amount of oxidation.

As shown in FIG. 2, the mayonnaise sample containing no EDTA had elevated amount of heptadienal, and thus oxidation, over the testing period when compared to the other samples. However, the levels of heptadienal in the mayonnaise samples containing about 100, 200 and 400 ppm of nicotianamine were comparable to the EDTA containing sample. Therefore, the presence of such amounts of nicotianamine was effective to impart a protective effect on the mayonnaise sample equivalent to EDTA.

It will be understood that various changes in the details, materials, and arrangements of formulations and ingredients, which have been herein described and illustrated in order to explain the nature of the products and methods herein may be made by those skilled in the art within the principle and scope of the disclosure as expressed in the appended claims.

What is claimed is:

1. An oxidatively stable comestible comprising:
a comestible base;
an effective amount of nicotianamine blended into the comestible base, the nicotianamine effective to provide oxidative stability at least equivalent to the comestible base having an amount of EDTA therein; and
wherein the comestible base is substantially free of EDTA.

2. The oxidatively stable comestible of claim 1, wherein the effective amount of nicotianamine includes about 60 to about 400 ppm of nicotianamine.

3. The oxidatively stable comestible of claim 1, wherein the comestible base is selected from the group comprising a food, a beverage, and a pharmaceutical.

4. The oxidatively stable comestible of claim 1, wherein the comestible base is a salad dressing.

5. The oxidatively stable comestible of claim 4, wherein the salad dressing is mayonnaise.

6. The oxidatively stable comestible of claim 1, wherein the effective amount of nicotianamine is effective to reduce formation of free radicals to less than about 2 microM Tempol equivalent after about 130 hours of incubation at about 37° C.

7. The oxidatively stable comestible of claim 1, wherein the effective amount of nicotianamine maintains the amount of heptadienal generated from the comestible to about 1500 ppb of less after about 7 weeks of storage at about 43° C.

8. A method of preparing an oxidatively stable nicotianamine containing product comprising:
providing a product selected from the group comprising a food, a beverage, and a pharmaceutical; and
combining an amount of nicotianamine effective to reduce oxidation of the product similar the product having EDTA wherein the product is substantially free of EDTA.

9. The method of claim 8, wherein the nicotianamine is added during formation of the product.

10. The method of claim 8, wherein the nicotianamine is added after formation of the product.

11. The method of claim 8, wherein the amount of nicotianamine is about 70 to about 400 ppm.

12. The method of claim 8, wherein the product is a salad dressing.

13. The method of claim 12, wherein the salad dressing is mayonnaise.

14. An oxidatively stable mayonnaise comprising:
mayonnaise having a pH of about 3 to about 5 and a titrateable acidity of about 0.2 to about 0.5;
about 70 to about 400 ppm of nicotianamine blended into the mayonnaise, the nicotianamine effective to provide oxidative stability at least equivalent to the mayonnaise having an amount of EDTA therein;
the nicotianamine effective to maintain the amount of heptadienal; generated from the mayonnaise to about 1500 ppb or less after about 7 weeks of storage at about 43° C.; and wherein the mayonnaise is substantially free of EDTA.

15. The oxidatively stable mayonnaise of claim 14, wherein the mayonnaise has less than about 2 micromolar Tempol equivalent after about 130 hours of incubation at about 37° C.
